(19) United States
(12) Patent Application Publication
(10) Pub. No.: US 2026/0103949 A1
(43) Pub. Date: Apr. 16, 2026

(54) CONDUIT SUPPORT ASSEMBLIES AND PROCESSES FOR USING SAME

(71) Applicant: SOFEC, INC., HOUSTON, TX (US)

(72) Inventors: WILLIAM L. FONTENOT, Houston, TX (US); STEPHEN P. LINDBLADE, Waller, TX (US)

(73) Assignee: SOFEC, INC., HOUSTON, TX (US)

(21) Appl. No.: 19/356,386

(22) Filed: Oct. 13, 2025

Related U.S. Application Data
(60) Provisional application No. 63/706,781, filed on Oct. 14, 2024.

(51) Int. Cl. E21B 19/00

(52) U.S. Cl. CPC E21B 19/004; E21B 19/008

(57) ABSTRACT

Conduit support assemblies and processes for using same. In some embodiments, the conduit support assembly can include a support apparatus configured to be disposed on a guide tube of a structure floating in water. The support apparatus can include a support tube, a load ring attached to the support tube and moveable relative to the support tube, a support shoulder, a first seal, and a split ring assembly. The conduit support assembly can also include a hang-off adapter configured to be secured to the conduit and can include a first load shoulder. The support apparatus can be configured to allow the hang-off adapter to pass partially through the support apparatus. The first load shoulder can be configured to engage with the split ring assembly and, when loaded, the first seal can be deformed to create a barrier between an exterior surface of the hang-off adaptor and the support apparatus.

### CROSS-REFERENCE TO RELATED APPLICATION

This application claims priority to U.S. Provisional Patent Application No. 63/706,781, filed on October 14, 2024, which is incorporated by reference herein

### FIELD

Embodiments described generally relate to conduit support assemblies and processes for using same. More particularly, such embodiments relate to conduit support assemblies for supporting a conduit from a floating structure and processes for using same.

### BACKGROUND

In the offshore oil and gas industry and in particular the deepwater segment of the oil and gas industry, it is common to have production facilities disposed on a floating structure with the producing well and other subsea infrastructure disposed on the seabed. The producing wells and subsea infrastructure are typically connected to the floating structure via one or more conduits, often referred to as risers. These conduits can be rigid pipes, flexible pipes, hoses, umbilicals, power cables, or other conduits. Such conduits are typically supported by the floating structure via a guide tube that is located below the surface of the water and extends into an interior space of the floating structure.

It is often necessary to replace existing conduits and/or to install new conduits supported by the floating structure when the floating structure is moored or otherwise secured to the seabed at an offshore location. This often requires divers or remotely operated vehicles, which can be inefficient, expensive, and time consuming.

There is a need, therefore, for improved conduit support assemblies for supporting a conduit from a structure floating in a body of water and process for using the same.

### SUMMARY

Conduit support assemblies and process for using same are provided. In some embodiments, a conduit support assembly can include a support apparatus configured to be disposed on a guide tube connected to a structure floating in a body of water. The support apparatus can include a support tube, a load ring, a first seal, and a split ring assembly. The load ring can be attached to the support tube toward a first end thereof. The load ring can be moveable relative to the support tube in a direction that is parallel to a longitudinal axis of the support apparatus. A support shoulder can be located toward a second end of the support tube and can extend from an inner surface thereof. The first seal can be disposed within the support tube between the load ring and an inner surface of the support shoulder. The split ring assembly can be configured to be movable between an open position and a closed position. The conduit support assembly can also include a hang-off adapter configured to be secured to a conduit having a first load shoulder disposed on an exterior surface thereof that can be configured to matingly engage with the split ring assembly when the split ring assembly is in the closed position. The support apparatus can be configured to allow the hang-off adapter to pass partially through the support apparatus from the second end toward the first end thereof when the split ring assembly is in the open position. The first load shoulder of the hang-off adapter can be configured to engage with the split ring assembly to transfer a load of the conduit from the hang-off adapter to the load ring when the hang-off adapter is secured to the conduit and the split ring assembly is in the closed position. When the load of the conduit is transferred from the hang-off adapter to the load ring, the first seal can be deformed to create a first barrier between an exterior surface of the hang-off adapter and the support apparatus.

In some embodiments, a process for connecting a conduit support assembly disposed on a structure floating in a body of water can include filling an interior space of the structure with water. A support apparatus of the conduit support assembly can be disposed on a first end of a guide tube that can be located within the interior space of the structure and in fluid communication with the body of water. The support apparatus can include a support tube, a load ring, a first seal, and a split ring assembly. The load ring can be attached to the support tube toward a first end thereof. A support shoulder can be located toward a second end of the support tube and can extend from an inner surface thereof. The first seal can be disposed on the inner surface of the support tube between the load ring and the support shoulder. The split ring assembly can be configured in an open position. The load ring can be moveable relative to the support tube in a direction that is parallel to a longitudinal axis of the support apparatus. A hang-off adapter of the conduit support assembly can be secured to the conduit. The hang-off adapter can include a first load shoulder disposed on an exterior surface thereof that can be configured to matingly engage with the split ring assembly when the split ring assembly is in a closed position. A cover of the conduit support assembly can be secured to or against the support apparatus or against a second end of the guide tube to at least partially restrict fluid communication between the interior space of the structure and the body of water. The process can also include removing the cover from the guide tube. The process can also include positioning the hang-off adapter partially within the support apparatus. The process can also include moving the split ring assembly from the open position to the closed position so that the first load shoulder matingly engages with the split ring assembly. The process can also include transferring a load of the conduit to the support apparatus via the split ring assembly and the first load shoulder of the hang-off adapter. The process can also include removing the water from the interior space of the structure.

In other embodiments, a process for connecting a conduit to a conduit support assembly disposed on a structure floating in a body of water can include filling an interior space of the structure with water. A support apparatus of the conduit support assembly can be disposed on a first end of a guide tube that can be located within the interior space of the structure and in fluid communication with the body of water. The support apparatus can include a support tube, a load ring attached to the support tube toward a first end thereof, a support shoulder located toward a second end of the support tube and extending from an inner surface thereof, a first seal disposed on the inner surface of the support tube between the load ring and the support shoulder, and a split ring assembly. The load ring can be moveable relative to the support tube in a direction that is parallel to a longitudinal axis of the support apparatus. A hang-off adapter of the conduit support assembly can be secured to the conduit. A cover of the conduit support assembly can be secured within or against the support apparatus or against a second end of the guide tube to at least partially restrict fluid communication between the interior space of the structure and the body of water. The process can also include removing the cover from the guide tube or the support apparatus. The process can also include positioning the hang-off adapter partially within the support apparatus. The hang-off adaptor can include a first load shoulder disposed on an exterior surface thereof that can be configured to matingly engage with the split ring assembly when the split ring assembly is in a closed position. The process can also include moving the split ring assembly from an open position to the closed position. The process can also include transferring a load of the conduit to the support apparatus via the split ring assembly and the first load shoulder of the hang-off adapter. The process can also include removing the water from the interior space of the structure.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification.

FIG. 1 depicts a cut-away side elevation view of an illustrative floating structure that includes a guide tube and a conduit support assembly, according to one or more embodiments described.

FIG. 2 depicts a partial cut-away side elevation view of an illustrative conduit support assembly, according to one or more embodiments described.

FIG. 3 depicts a partial cut-away side elevation view of the assembly shown in FIG. 2 during installation of a conduit, according to one or more embodiments described.

FIG. 4 depicts a detailed cut-away side elevation view of a portion of the assembly shown in FIG. 3.

FIG. 5 depicts a detailed cut-away side elevation view of a portion of the assembly shown in FIG. 2.

FIG. 6 depicts a partial cut-away side elevation view of another illustrative conduit support assembly that includes a first seal and a second seal, according to one or more embodiments described.

FIG. 7 depicts a partial cut-away side elevation view of the illustrative conduit support assembly shown in FIG. 6 during installation of a conduit, according to one or more embodiments described.

FIG. 8 depicts a detailed cut-away side elevation view of a portion of the conduit support assembly shown in FIG. 7.

FIG. 9 depicts a detailed cut away side elevation view of a portion of the conduit support assembly shown in FIG. 6.

FIG. 10 depicts a plan view of an illustrative split ring assembly for engaging with a hang-off adapter of a conduit support assembly, according to one or more embodiments described.

FIG. 11 depicts a cut-away elevation view of an illustrative cover secured to or against a support apparatus of the conduit support assembly shown in FIGS. 2-5, according to one or more embodiments described.

FIG. 12 depicts a cut-away elevation view of the cover of the conduit support assembly shown in FIG. 11 in an unsecured state, according to one or more embodiments described.

FIG. 13 depicts a cut-away elevation view of another illustrative cover secured within a support apparatus of the conduit support assembly shown in FIGS. 6-9, according to one or more embodiments described.

FIG. 14 depicts a cut-away elevation view of the assembly and cover shown in FIG. 13 in an unsecured state, according to one or more embodiments described.

FIGS. 15 to 18 depict a process for connecting a conduit to a conduit support assembly disposed on a structure floating in a body of water, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

It should also be understood that the phrases “disposed therein”, “disposed within”, “disposed on” and other similar phrases, when describing a component, e.g., a cover, describe the component as being partially disposed therein/within/on or completely disposed therein/within/on. For example, if the component is a cover disposed within a guide tube, the cover can be disposed partially within the guide tube or completely within the guide tube.

The terms “rotate”, “rotation”, “rotatable”, and “rotating” are used interchangeably and refer to the partial or complete turning of a body around an axis or center point.

The term “substantially” when used in the context of “substantially perpendicular” means a first line and a second line that are coplanar and intersect one another are orientated at angles of about 80 degrees, about 83 degrees, about 85 degrees, about 87 degrees, or about 89 degrees to about 91 degrees, about 93 degrees, about 95 degrees, about 97 degrees, or about 100 degrees with respect to one another.

The term “substantially” when used in the context of “substantially parallel” means an axis and a plane (e.g., the surface of a body of water) are orientated at angles of about 160 degrees, about 165 degrees, about 170 degrees, about 175 degrees, or about 180 to about 185 degrees, about 190 degrees, about 195 degrees, or about 200 degrees with respect to one another.

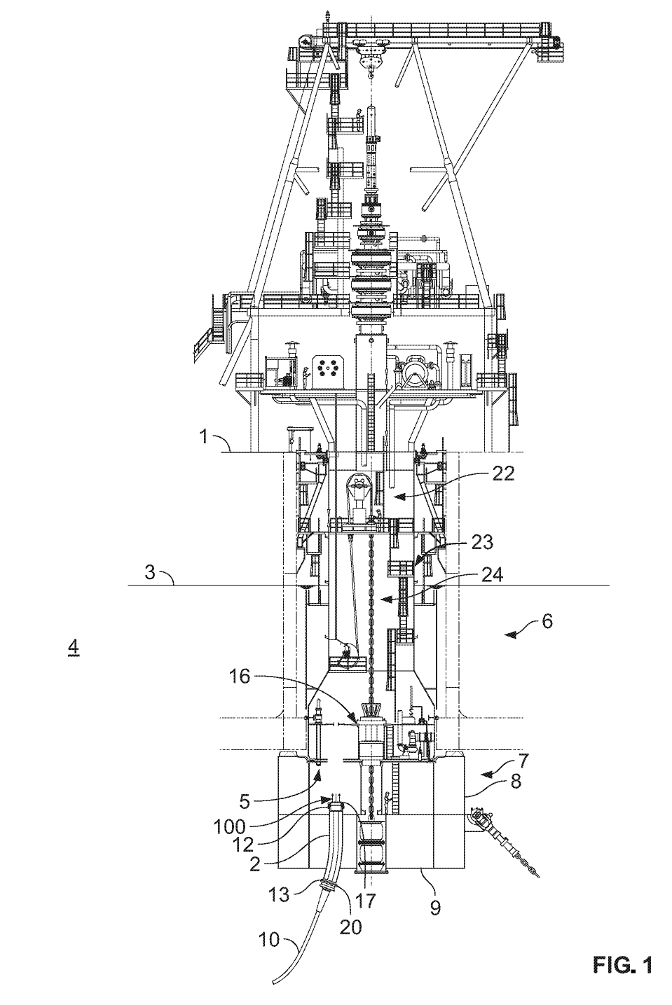

FIG. 1 depicts a cut-away side elevation view of an illustrative floating structure 1 that includes a guide tube 2 and a conduit support assembly 100 for supporting a conduit 10, according to one or more embodiments. In some embodiments, the conduit support assembly 100 can be disposed on or secured to the guide tube 2 of the floating structure 1 that can be floating on a surface 3 of a body of water 4. The floating structure 1 can be a vessel, for example a barge, a floating production, storage, and offloading (FPSO) facility, a floating, storage, and offloading (FSO) facility, a semisubmersible, a tension leg platform (TLP), or any other type of floating structure. The guide tube 2 can be disposed on the floating structure 1 below the surface 3 of the body of water 4 and can be configured to provide fluid communication between the body of water 4 and an interior space 22 of the floating structure 1.

In some embodiments, the floating structure 1 can be moored to a seabed via a disconnectable turret mooring system 6, as shown in FIG. 1. In other embodiments, the floating structure 1 can be moored to the seabed with a permanent turret mooring system (not shown) or a spread mooring system (not shown). When the floating structure 1 is moored to the seabed via the disconnectable turret mooring system 6, the disconnectable turret mooring system 6 can include a buoy 7 that can be releasably attached to a turret shell or turret shaft 23 via a mechanical connector 16. In some embodiments, the turret shaft 23 can be disposed within a moonpool of the floating structure 1. In such embodiments, the guide tube 2 can be disposed toward a bottom plate 9 of the buoy 7, as shown in FIG. 1, and can provide fluid communication between the body of water 4 and an interior space 5 of the buoy 7. In other embodiments, the guide tube 2 can be disposed through a side shell 8 of the buoy 7 and can provide fluid communication between the body of water 4 and the interior space 5 of the buoy 7. In still other embodiments, the guide tube 2 can be disposed through a side shell (not shown) of the turret shaft 23 and can provide fluid communication between the body of water 3 and an interior space 24 of the turret shaft 23. In still other embodiments, the guide tube 2 can provide fluid communication between the body of water 4 and an interior space 22 of the structure 1 (not shown).

In some embodiments, the guide tube 2 can be configured with a flange 17 at a first end 12 of the guide tube 2 to which the conduit support assembly 100 can be secured. In some embodiments, a second end 13 of the guide tube 2 can also be configured with a flange 20. In some other embodiments, not shown, the guide tube 2 can be configured only with the flange 20 at the second end 13 thereof.

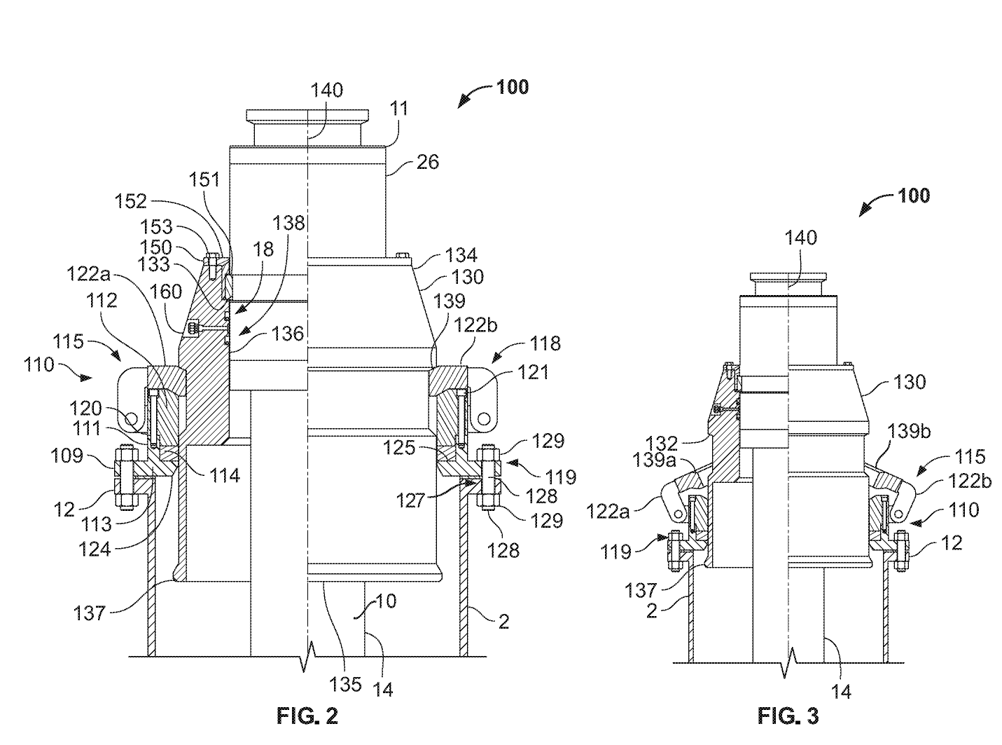

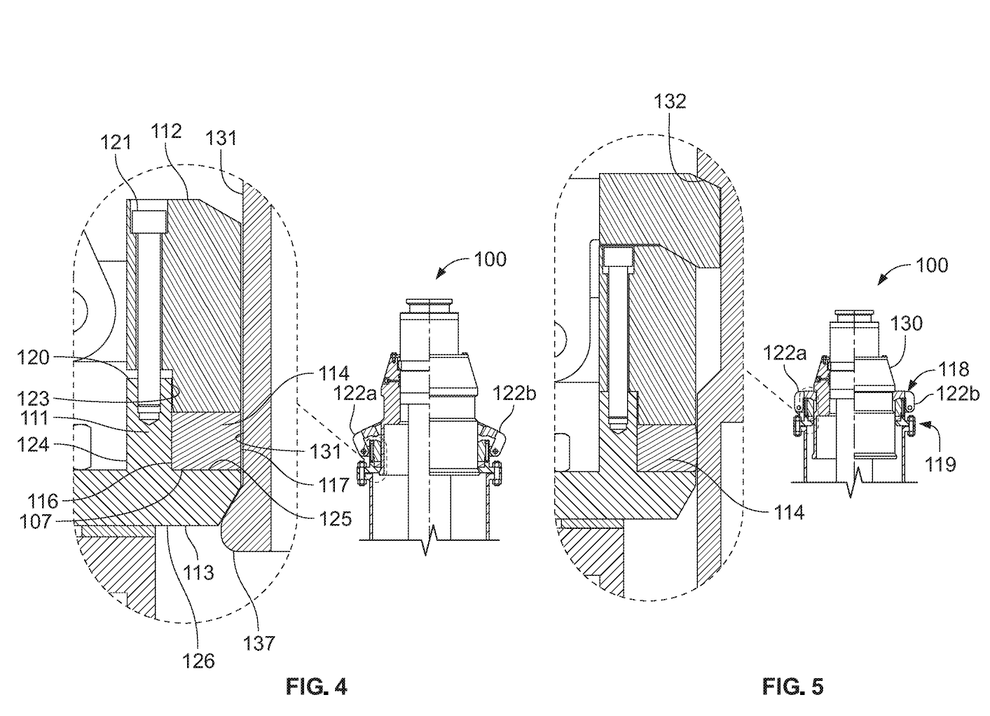

FIG. 2 depicts a partial cut-away side elevation view of an illustrative conduit support assembly 100, according to one or more embodiments. FIG. 3 depicts a partial cut-away side elevation view of the assembly 100 shown in FIG. 2 during installation of a conduit 10, according to one or more embodiments. FIG. 4 depicts a detailed cut-away side elevation view of a portion of the conduit support assembly 100 shown in FIG. 3. FIG. 5 depicts a detailed cut-away side elevation view of a portion of the conduit support assembly 100 shown in FIG. 2.

Referring to FIGS. 2-5 collectively, in some embodiments, the conduit support assembly 100 can include a support apparatus 110 and a hang-off adapter 130. In some embodiments, the support apparatus 110 can include a support tube 111, a load ring 112, a support shoulder 113, a seal 114, and a split ring assembly 115. In some embodiments the support tube 111 can be a tubular structure, for example a steel pipe or a steel ring. In some embodiments, the support tube 111 can be fitted with a flange 109 about an outer surface of the support tube 111 at a second end 124 thereof. In some embodiments, the support apparatus 110 can be secured to the first end 12 of the guide tube 2 via a plurality of fasteners 127. In some embodiments, as shown, the plurality of fasteners 127 can each include a stud 128 and at least two nuts 129 configured to threadingly engage opposing ends of the stud 128. In other embodiments, the plurality of fasteners 127 can include a rivet or a bolt and a nut. In still other embodiments, the support apparatus 110 can be secured to the first end of the guide tube 2 via welding.

In some embodiments, the load ring 112 can be disposed on the support tube 111 at or toward a first end 120 thereof via a plurality of fasteners 121. In some embodiments, the load ring 112 can be moveable relative to the support tube 111 in a direction that is parallel to a longitudinal axis 140 of the support assembly 100. In some embodiments, the support shoulder 113 can be disposed on, welded to, formed on, integral with, or otherwise attached to the support tube 111 at or toward the second end 124 thereof. In some embodiments the support shoulder 113 can extend from an inner surface 123 of the support tube 111.

In some embodiments, the seal 114 can be disposed within the support tube 111 between the load ring 112 and an inner surface 125 of the support shoulder 113. In other embodiments, the seal 114 can be disposed within the support tube 111 between the load ring 112 and the inner surface 123 of the support tube 111. In some embodiments, as shown, the seal 114 can be disposed within the support tube 111 between the load ring 112, the inner surface 125 of the support shoulder 113, and against the inner surface 123 of the support tube 111. In some embodiments the seal 114 can be formed from a polymer. In some embodiments, the seal 114 can be formed from an elastomeric material, for example a rubber compound or other elastomeric material such that the seal 114 can deform when it is subjected to a load.

In some embodiments, when the seal 114 is subjected to a load, for example a load from the conduit 10, that is at least partially parallel to the longitudinal axis 140, the seal 114 can be deformed or compressed in a direction that is parallel to the longitudinal axis 140 and can be expanded in a direction that is perpendicular or normal to the longitudinal axis 140. In some embodiments, when the load of the conduit 10 is transferred from the hang-off adapter 130 to the load ring 112, the seal 114 can be deformed to create a barrier between an exterior or outer surface 131 of the hang-off adapter 130 and the support apparatus 110. In some embodiments, when the seal 114 expands in a direction that is perpendicular or normal to the longitudinal axis 140, an inner surface 117 of the seal 114 can abut against the exterior or outer surface 131 of the hang-off adaptor 130 and an exterior or outer surface 116 of the seal 114 can abut against the inner surface 123 of the support tube 111 to create a barrier. Said another way, when the seal 114 expands the seal 114 can prevent or at least partially restrict fluid communication between the body of water 4 and the interior space 5 of the buoy and/or the interior space 22 of the structure 1 (see FIG. 1), and/or the interior space 24 of the turret shaft 23 of the disconnectable turret mooring system 6.

In some embodiments, the interior space 5 of the buoy 7 and the interior space 24 of the turret shaft 23 can be in fluid communication with one another. In some embodiments, when the seal 114 is compressed between the load ring 112 and the inner surface 125 of the support shoulder 113, the exterior or outer surface 116 of the seal 114 can abut against the inner surface 123 of the support tube and/or a lower surface 107 of the seal 114 can abut against the inner surface 125 of the support shoulder 113 and the inner surface 117 of the seal 114 can abut against the exterior or outer surface 131 of the hang-off adaptor 130 to create the barrier, or said another way, to prevent or at least partially restrict fluid communication between the body of water 4 and the interior space 5 of the buoy 7 and/or the interior space 24 of the turret shaft 23 (see FIG. 1). In some embodiments, the barrier can be watertight or a watertight barrier.

In some embodiments, the split ring assembly 115 can be configured to be moveable between an open position, as shown in FIGS. 3 and 4, and a closed position, as shown in FIGS. 2 and 5. In some embodiments, the split ring assembly 115 can include two ring segments 122a, 122b, as shown in FIGS. 2 through 5. In other embodiments, the split ring assembly 115 can include 3, 4, 5, 6, 7, 8 or even more ring segments. In some embodiments, the ring segments 122a, 122b of the split ring assembly 115 can be rotatively attached to the load ring 112 as shown in FIGS. 2 to 5. In other embodiments, not shown, the split ring assembly 115 can be rotatively attached to the support tube 111.

In some embodiments, the split ring assembly 115 can be configured such that the split ring assembly 115 can move from the closed position to the open position without intervention as a first end 134 of the hang-off adaptor 130 passes though the split ring assembly 115. In some embodiments, the split ring assembly 115 can move from the open position to the closed position without intervention. In some embodiments, the split ring assembly 115 can move from the open position to the closed position without intervention and only under the influence of gravity after a first load shoulder 132 of the hang-off adaptor 130 passes through the split ring assembly 115. In some embodiments, each ring segment 122a, 122b of the split ring assembly 115 can be configured with a load shoulder 139a and 139b, respectively. In some embodiments, the load shoulders 139a, 139b of the ring segments 122a, 122b can be configured to matingly engage with the first load shoulder 132 of the hang-off adaptor 130. In some embodiments, the split ring assembly 115 can be moved from the open position to the closed position or from the closed position to the open position via one or more actuators, not shown. In some embodiments, the actuator can be a hydraulic actuator, a pneumatic actuator, an electric actuator, or any combination thereof.

In some embodiments, the hang-off adapter 130 can be configured to be secured to the conduit 10. In some embodiments, the hang-off adapter 130 can be secured to the conduit 10 via a mechanical connector 150. In other embodiments, the hang-off 130 adapter can be welded to or formed on or around the conduit 10. In some embodiments, not shown, the hang-off adapter 130 can be an integral part of an end termination 11 of the conduit 10. In some embodiments, the first load shoulder 132 can be configured to matingly engage with the ring segments 122a, 122b of the split ring assembly 115 to transfer a load from the conduit 10 to the split ring assembly 115 and the load ring 112. In some embodiments, the portion of the exterior or outer surface 131 of the hang-off adaptor 130 that can contact the seal 114 can be referred to as a sealing surface. In some embodiments, the sealing surface of the exterior or outer surface 131 of the hang-off adaptor 130 can be a smooth or polished exterior or outer surface that can be disposed on or can be a part of the hang-off adaptor 130.

In some embodiments, the hang-off adaptor 130 can be configured with a second load shoulder 133. In some embodiments, an exterior or outer surface 14 conduit 10 or an exterior or outer surface 25 of an end termination 11 of the conduit 10 can define a groove 18. In some embodiments, as shown, the groove 18 can have a rectangular cross section. In some embodiments, the mechanical connector 150 can include a mating ring 151 and a retainer ring 152. In some embodiments, the mating ring 151 can be partially disposed within the groove 18 defined by exterior or outer surface 14 the conduit 10 or the exterior or outer surface 26 the end termination 11 of the conduit 10. In some embodiments the retainer ring 152 can be configured to secure the mating ring 151 partially within the groove 18 defined by the conduit 10 or end termination 11 of the conduit 10 and partially on the second load shoulder 133 of the hang-off adapter 130 such that the load of the conduit 10 can be transferred from the conduit 10 to the hang-off adapter 130 via the mating ring 151. The retainer ring 152 can secure the mating ring 151 partially within the groove 18 defined by the conduit 10 or end termination 11 of the conduit 10 and on the second load shoulder 133 of the hang-off adapter 130. In some embodiments, the retainer ring 152 can be secured to the hang-off adaptor 130 via a plurality of fasteners 153.

As shown in FIGS. 3 and 5, in some embodiments, when the split ring assembly 115 is in the open position, the support apparatus 110 can allow the hang-off adapter 130 to pass at least partially though the support apparatus 110 from a second end 119 of the support apparatus 110 toward a first end 118 of the support apparatus 110. As shown in FIGS. 2 and 4, when the split ring assembly 115 is in the closed position and the first load shoulder 132 is matingly engaged with the ring segments 122a, 122b or the load shoulders 139a, 139b of the ring segments 122a, 122b, respectively, of the split ring assembly 115, a load of the conduit 10, for example a tension load of the conduit 10, can be transferred from the hang-off adaptor 130, to the load ring 112 via the split ring assembly 115. When the load is transferred to the load ring 112, the load ring 112 can be displaced toward the seal 114 and the support shoulder 113 in a direction that is parallel with the longitudinal axis 140 of the conduit support assembly 100. In some embodiments, when the load of the conduit 10 is transferred from the hang-off adaptor 130 to the load ring 112, the seal 114 can be deformed or compressed. In such embodiments, as described above, the seal 114 can be deformed to create the barrier between the hang-off adaptor 130 and the support apparatus 110.

In some embodiments, the hang-off adaptor 130 of the conduit support assembly 100 can include a stop shoulder 137. In some embodiments, the stop shoulder 137 can be disposed on an exterior or outer surface of the hang-off adaptor 130. In some embodiments, the stop shoulder 137 can be disposed on the hang-off adaptor 130 toward a second end 135 of the hang-off adaptor 130 and can be configured to prevent the hang-off adaptor 130 from passing completely through the support apparatus 110. In some embodiments, the stop shoulder 137 can provide the hang-off adaptor 130 with an outer dimension, for example an outer diameter that is greater than an inner dimension of the support apparatus 110, for example an inner diameter the support shoulder 113. In some embodiments, the stop shoulder 137 can be a continuous ring. In other embodiments, the stop shoulder 137 can include one or more tabs or protrusions disposed on the hang-off adaptor 130. In some embodiments, the stop shoulder 137 can be configured to prevent the hang-off adaptor from passing completely through the support apparatus 110 from the second end 124 of the support tube 111 and through the first end 118 of the support tube 111.

In some embodiments, the hang-off adaptor 130 can define an injection port 160. In some embodiments, the injection port 160 can provide fluid communication to an annulus defined by an interior surface 136 of the hang-off adaptor 130 and the exterior or outer surface 14 of the conduit 10 or the exterior or outer surface 26 of the end termination 11 of the conduit 10. In some embodiments, the injection port 160 can be utilized to inject, insert, or otherwise dispose a sealant or an epoxy into the annulus defined by the interior surface 136 of the hang-off adaptor 130 and the exterior or outer surface 14 of the conduit 10 or the exterior or outer surface 26 of the end termination 11 of the conduit 10 to create a barrier or water tight barrier between the interior surface 136 of the hang-off adaptor 130 and the exterior or outer surface 14 of the conduit 10 or the exterior or outer surface 26 of the end termination 11 of the conduit 10.

In some embodiments, the hang-off adaptor 130 can include at least one optional seal groove 138, two are shown. The seal groove(s) 138 be configured to receive a seal ring or an o-ring (not shown) that can provide a barrier or a watertight barrier between the interior surface 136 of the hang-off adaptor 130 and the exterior or outer surface 14 of the conduit 10 or an exterior or outer surface 26 of the end termination 11 of the conduit 10. In some embodiments, the injection port 160 can be used to inject a sealant into the annulus between exterior or outer surface 14 of the conduit 10 or exterior or outer surface 26 of the end termination 11 of the conduit 10 and the interior surface 136 of the hang-off adaptor 130 to fill at least a portion of any voids or other gaps between the exterior or outer surface 14 of the conduit 10 or the exterior or outer surface 26 of the end termination 11 of the conduit 10 and the interior surface 136 of the hang-off adaptor 130.

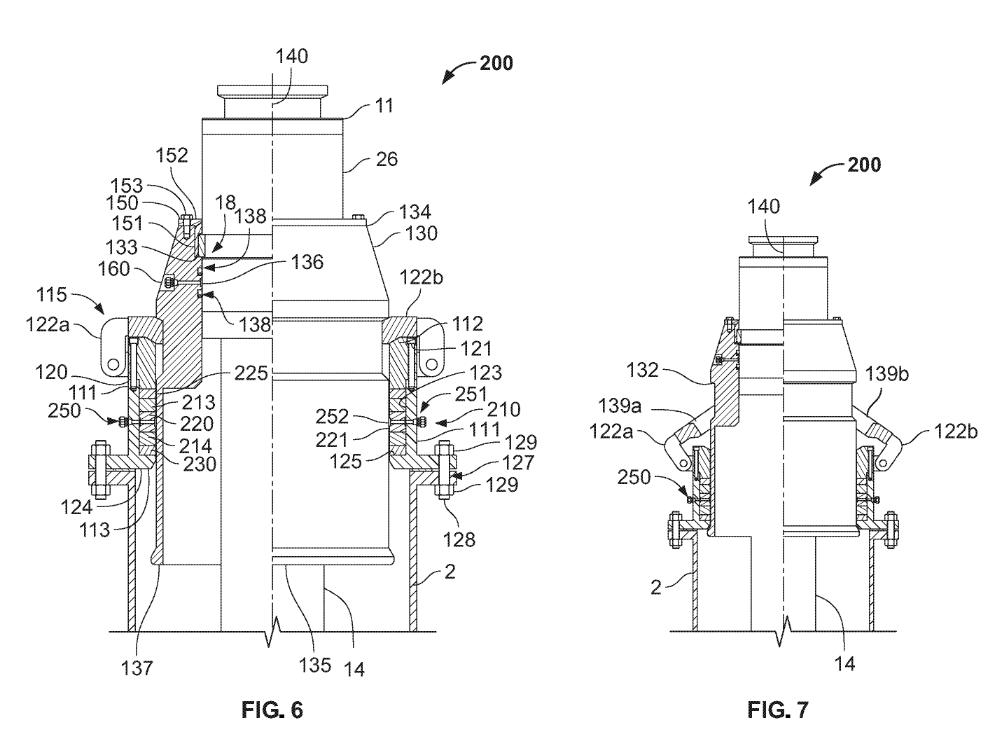

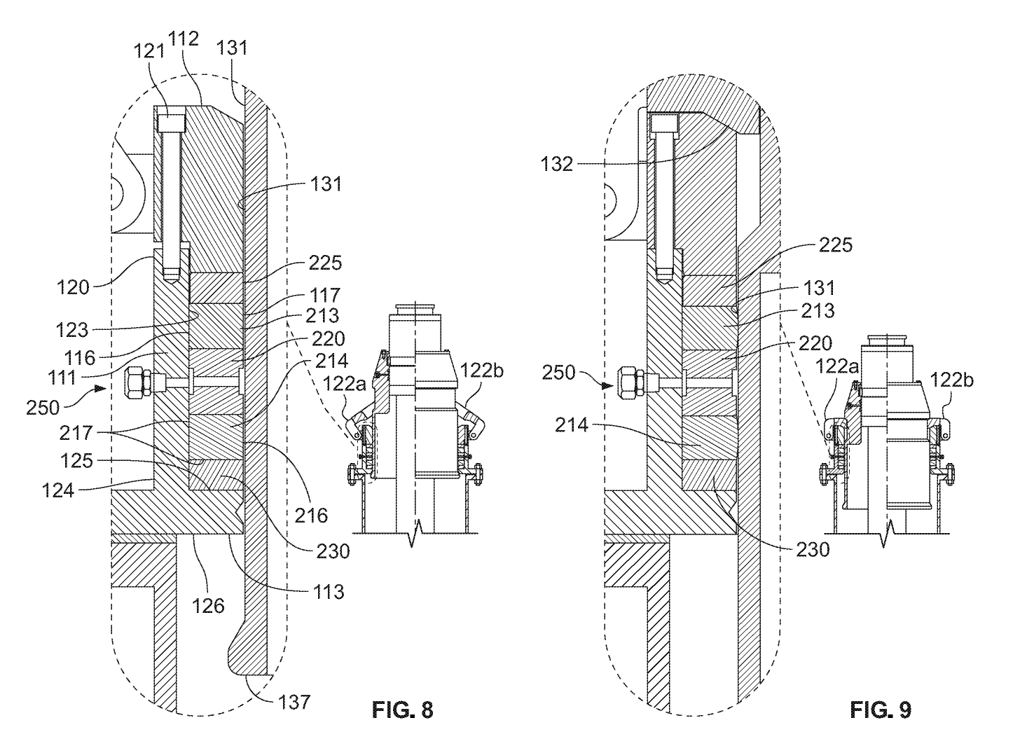

FIG. 6 depicts a partial cut-away side elevation view of another illustrative conduit support assembly 200 that includes a first seal 213 and a second seal 214, according to one or more embodiments. FIG. 7 depicts a partial cut-away side elevation view of the illustrative assembly 200 shown in FIG. 6 during installation of the conduit 10, according to one or more embodiments. FIG. 8 depicts a detailed cut-away side elevation view of a portion of the assembly 200 shown in FIG. 7. FIG. 9 depicts a detailed cut-away side elevation view of a portion of the assembly 200 shown in FIG. 6. The conduit support assembly 200 depicted in FIGS. 6-9 is similar to the conduit support assembly 100 shown in FIGS. 2 to 5, with a main difference being that the conduit support assembly 200 includes the second seal 214 and a spacer ring or in some embodiments a “first” spacer ring 220. In some embodiments, the conduit support assembly 200 can optionally include a second spacer ring 225 and/or a third spacer ring 230, as shown. In some embodiments, the support apparatus 210 can also include an injection port 250. In some embodiments, the optional second and third spacer rings 225, 230 can each be similar in design to that of the first spacer ring 220.

In some embodiments, the second seal 214 can be disposed within the support tube 111 between the load ring 112 and the inner surface 125 of the support shoulder 113. In other embodiments, the first seal 213 can be disposed toward the inner surface 123 of the support tube 111 between the load ring 112 and the first spacer ring 220 and the second seal 214 can be disposed toward the inner surface 123 of the support tube 111 between the first spacer ring 220 and the support shoulder 113. In some embodiments, the first spacer ring 220 can be disposed toward the inner surface 123 of the support tube 111 between the first seal 213 and the second seal 214. In some embodiments, the spacer ring 220, the first seal 213 and the second seal 214 can be moveable relative to the support tube 111 in a direction that is at least substantially parallel to the longitudinal axis of the assembly 140.

As shown in FIGS. 6 and 9, when the split ring assembly 115 is in the closed position and the first load shoulder 132 is matingly engaged with the split ring assembly 115, a load of the conduit 10, for example a tension load of the conduit 10, can be transferred from the hang-off adaptor 130, to the load ring 112 via the ring segments 122a, 122b of the split ring assembly 115. When the load is transferred to the load ring 112, the load ring 112 can be displaced toward the first seal 213, the second seal 214, the first spacer ring 220, the second spacer ring 225, the third spacer ring 230, and the support shoulder 113 in a direction that is parallel with the longitudinal axis 140 of the conduit support assembly 200. In some embodiments, when the load of the conduit 10 is transferred from the hang-off adaptor 130 to the load ring 112, the first seal 213 and the second seal 214 can each be deformed.

In some embodiments, the second seal 214 can be formed from a polymer. In some embodiments, the second seal 214 can be formed from an elastomeric material, for example a rubber compound or other elastomeric material such that the second seal 214 deforms when it is subjected to a load. In some embodiments when the second seal 214 is subjected to a load, for example a load from a conduit 10 that is at least partially parallel to the longitudinal axis 140, the second seal 214 can be compressed in a direction that is parallel to the longitudinal axis 140 and can be expanded in a direction that is perpendicular or normal to the longitudinal axis 140. In some embodiments, when the load of the conduit 10 is transferred from the hang-off adaptor 130 to the load ring 112, the second seal 214 can be compressed between the first spacer ring 220 and the third spacer ring 230, or between the first spacer ring 220 and the inner surface 125 of the support shoulder 113 in a direction that is parallel to the longitudinal axis 140 and the second seal 214 can simultaneously expand in a direction that is perpendicular or normal to the longitudinal axis 140.

In some embodiments, when the second seal 214 expands in a direction that is perpendicular or normal to the longitudinal axis 140, an inner surface 216 of the second seal 214 can abut against the external surface 131 of the hang-off adaptor 130 and the exterior or outer surface 217 of the second seal 214 can abut against the inner surface 123 of the support tube 111 to create a second barrier. Said another way, when the second seal 214 expands, the inner surface 216 of the second seal 214 can abut against the external surface 131 of the hang-off adaptor 130 and the exterior or outer surface 217 of the second seal 214 can abut against the inner surface 123 of the support tube 111 to create a second barrier that can prevent or at least partially restrict fluid communication between the body of water 4 and the interior space 5 of the buoy 7, or the interior space 24 of the turret shaft 23, or the interior space 22 of the structure 1. In some embodiments, when the second seal 214 is compressed between the first spacer ring 220 and the third spacer ring 230, or between the first spacer ring 220 and the inner surface 125 of the support shoulder 113, the exterior or outer surface 217 of second seal 214 can abut against the inner surface 125 of the support shoulder 113 and the inner surface 216 of the second seal 214 can abut against the exterior or outer surface 131 of the hang-off adaptor 130 to create the second barrier, or said another way, to prevent or at least partially restrict fluid communication between the body of water 4 and the interior space 5 of the buoy 7, or the interior space 24 of the turret shaft 23, or the interior space 22 of the structure 1 via the guide tube 2. In some embodiments, the second barrier can be watertight.

As noted above, the support apparatus 210 can include the injection port 250. In some embodiments, the support tube 111 and the first spacer ring 220 can define the injection port 250 therethrough. In some embodiments, the optional second and third spacer rings 225, 230 can be free of an injection port 250 as shown in FIG. 6. In other embodiments, not shown, the optional second spacer ring 225 and/or the optional third spacer ring 230 can define an injection port 250 therethrough. In some embodiments, the injection port 250 can be in fluid communication with a volume defined by the first seal 213, the second seal 214, an inner surface 221 of the first spacer ring 220, and the exterior or outer surface 131 of the hang-off adaptor 130. Said another way, in some embodiments, the support tube 111 can define a bore 251 therethrough and the first spacer ring 220 can define a bore 252 therethrough and the bore 251 defined by the support tube 111 the bore 252 defined by the first spacer ring 215 can each be in fluid communication with one another and with the volume defined by the first seal 213, the second seal 214, the inner surface 221 of the first spacer ring 220, the inner surface 123 of the support tube 111, an exterior surface of the first spacer ring 220, and the exterior or outer surface 131 of the hang-off adaptor 130. In some embodiments, the bore 251 defined by the support tube 111 and the bore 252 defined by the first spacer ring 220 can be in fluid communication with one another when the first seal 213 and the second seal 214 are compressed by the load of the conduit 10 and can be in fluid communication with one another when the first seal 213 and the second seal 214 are in an uncompressed state, for example when the first seal 213 and the second seal 214 are each free from or not subjected to the load of the conduit 10.

In some embodiments, the injection port 250 can be utilized to inject, insert or otherwise dispose an epoxy, filler, or sealant, or any other fluid material into the volume defined by the first seal 213, the second seal 214, the inner surface 221 of the first spacer ring 220, the interior surface 123 of the support tube 111, the exterior surface of the first spacer ring 220, and the exterior or outer surface 131 of the hang-off adaptor 130 to provide a backup or alternate sealing method to prevent or restrict fluid communication between the body of water 4 and the interior space 5 of the buoy 7, or the interior space 24 of the turret shaft 23, or the interior space 22 of the structure 1 via the guide tube 2. In some embodiments, the first, second, and third spacer rings 220, 225, 230 can be formed or manufactured from a rigid material, e.g., a metallic or a steel plate, a flexible or semiflexible material, e.g., a polymer, or any other suitable material or combination of materials.

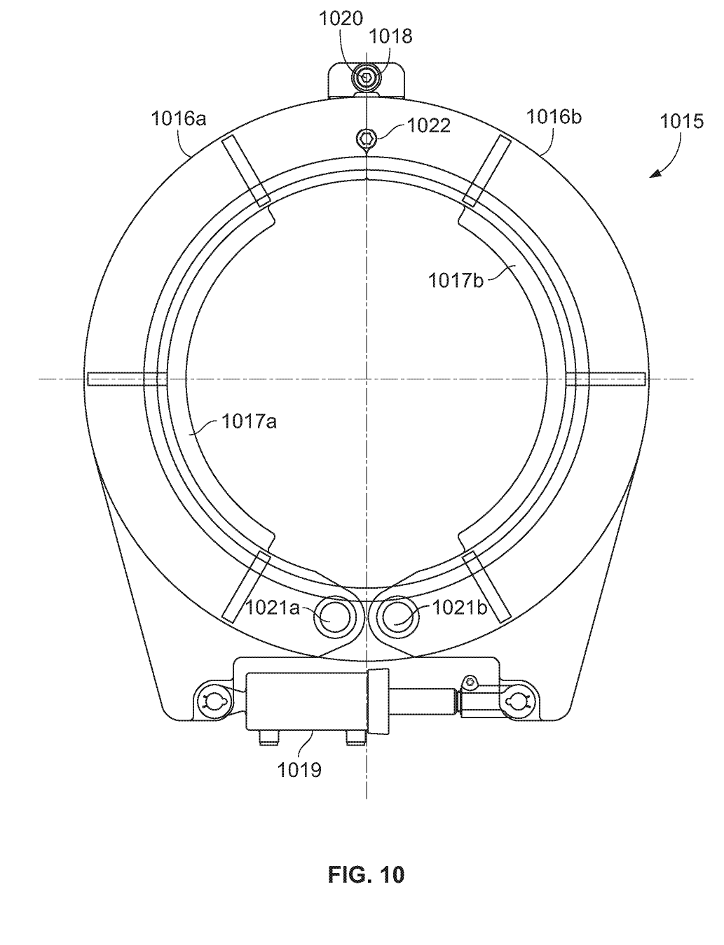

FIG. 10 depicts a plan view of an illustrative split ring assembly 1015 for engaging with the hang-off adapter 130 in the conduit support assemblies 100, 200 for supporting the conduit 10. The split ring assembly 1015 is an alternative embodiment to the split ring assembly 115 and is compatible with the conduit support assemblies 100 and 200. In some embodiments, the split ring assembly 1015 can include at least two ring segments 1016a, 1016b that can be connected to one another via a pin 1018. In some embodiments, the two ring segments 1016a, 1016b can each have or define a load shoulder 1017a and 1017b, respectively, that can be configured to matingly engage with the first load shoulder 132 of the hang-off adaptor 130 to transfer a load of the conduit 10 from the hang-off adapter 130 to the load ring 115 when the hang-off adapter 130 is secured to the conduit 10 and the split ring assembly 1015 is in the closed position. In some embodiments, when the split ring assembly 1015 is in the open position, the split ring assembly 1015 can be configured to allow the hang-off adaptor 130 to pass at least partially though the split ring assembly 1015.

In some embodiments, the ring segments 1016a, 1016b can be rotatable or otherwise moveable with respect to an axis 1020 that is parallel to the longitudinal axis 140, i.e. normal to the page of FIG. 10. In some embodiments, the pin 1018 can be aligned along the axis 1020. In some embodiments, the split ring assembly 1015 can include one or more actuators 1019. In some embodiments, the actuator 1019 can be configured to move the split ring 1015 assembly from a closed position, as shown, to an open position, not shown. In some embodiments, the ring segments 1016a and 1016b can each rotate about a rotation pin or simply pin 1021a and 1021b, respectively. In some embodiments, the split ring assembly 1015 can include an alignment shoulder 1022 that can facilitate alignment of the free ends of the ring segments 1016a and 1016b when brought together. In some embodiments, the actuator 1019 can be a hydraulic cylinder, a screw jack, a pneumatic actuator, or any other type of actuator or any combination thereof. In some embodiments, the split ring assembly 1015 can be configured to be moveable from an open position (not shown) to the closed position, as shown, via the actuator 1019.

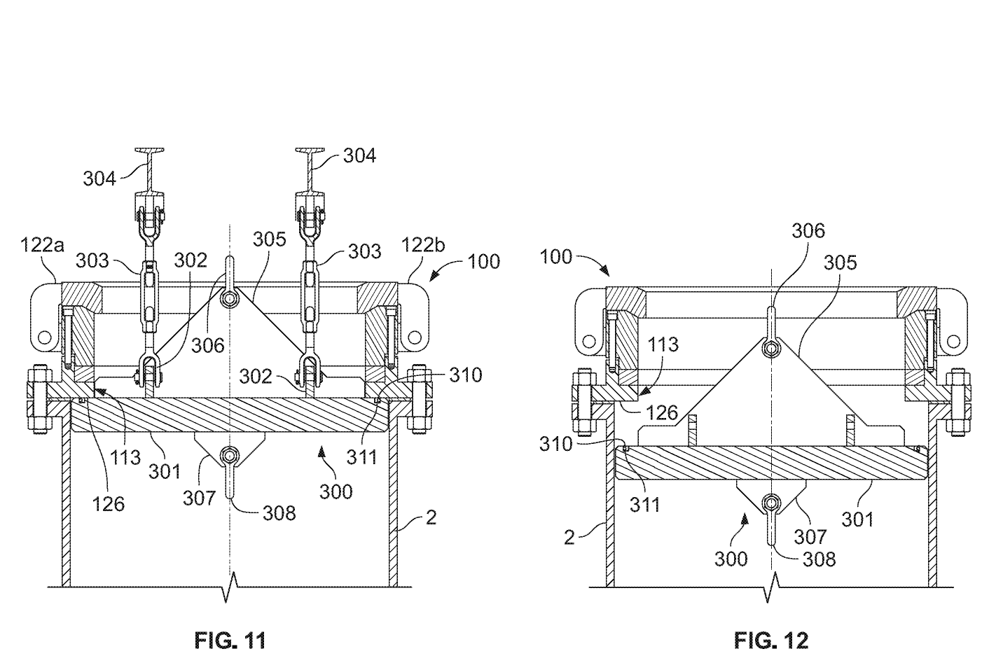

FIG. 11 depicts a cut-away elevation view of an illustrative cover 300 that can be connected to the support apparatus 110 of the conduit support assembly 100 secured against the support shoulder 113, according to one or more embodiments. It should be understood that the cover 300 can also be secured against the support shoulder 113 of the support apparatus 210 of the conduit support assembly 200. In some embodiments, the cover 300 can be secured against the support apparatus 110 of the conduit support assembly 100 or the support apparatus 210 of the conduit support assembly 200. FIG. 12 depicts a cut-away elevation view of the cover 300 of the conduit support assembly 100 in an unsecured state, according to one or more embodiments. Referring to FIGS. 11, and 12 collectively, in some embodiments, the cover 300 can be secured against an exterior or outer surface 126 of the support shoulder 113. In some embodiments, the cover 300 can include a cover plate 301 and at least one padeye 302, two are shown. In some embodiments, the cover 300 can include at least one securing member 303 two are shown, to secure the cover 300 to a structural support 304 of the floating structure 1 such that the cover plate 301 abuts or is secured against the exterior or outer surface 126 of the support shoulder 113. In some embodiments, the securing member 303 can be a turnbuckle (as shown), or a hydraulic cylinder, or a cable, or a wire or other apparatus or combination of apparatus suitable to apply a force to the cover 300 to secure the cover plate 301 against the exterior or outer surface 126 of the support shoulder 113. In other embodiments, the cover 300 can be configured such that the cover plate 301 can be secured against the second end 13 of the guide tube 2, not shown.

In some embodiments, the securing member 303 can be connected to the padeye 302 of the cover 300 and to the structural support 304 of the floating structure 1. In some embodiments, the structural support 304 of the floating structure 1 can be disposed within the interior space 5 of the buoy 7 (see FIG. 1). In some embodiments, the cover 300 can include a first bracket 305 and a first shackle 306 attached thereto. Optionally, as shown, the cover 300 can include a second bracket 307 and a second shackle 308 attached thereto. In some embodiments, the first bracket 305, the first shackle 306, the second bracket 307, and the second shackle 308, if present, can be used to install or remove the cover from the support apparatus 110 or the second end 13 of the guide tube 2.

In some embodiments, the cover 300 can include a seal 310. In some embodiments, the seal 310 can be configured to be disposed between the cover 300 and the exterior or outer surface 126 of the support shoulder 113, the support apparatus 110, or the second end 13 of the guide tube 2. In some embodiments, the cover can define a cover groove 311. In some embodiments, the seal 310 can be at least partially disposed within the cover groove 311. In some embodiments, the exterior or outer surface 126 of the support shoulder 113 or the second end 13 of the guide tube 2, and the seal 310 and cover plate 310 can create a barrier to at least partially prevent or restrict fluid communication between the body of water 4 and the interior space 5 of the buoy 7 via the guide tube 2. In some embodiments, the barrier that can be provided by the seal 310 can be a watertight barrier.

In some embodiments, the cover 300 can be removed or disengaged from the support apparatus 110/210 by releasing the securing member 303 from the padeye 302 and/or the structural support 304 and moving the cover 300 in a direction that is substantially parallel to the longitudinal axis 140 of the conduit support assembly 100/200 and away from the support apparatus 110 or support shoulder 113. In some embodiments, the cover 300 can be disposed within the guide tube 2. In some embodiments, the cover 300 can have an outer diameter that is less than an inner diameter of the guide tube 2.

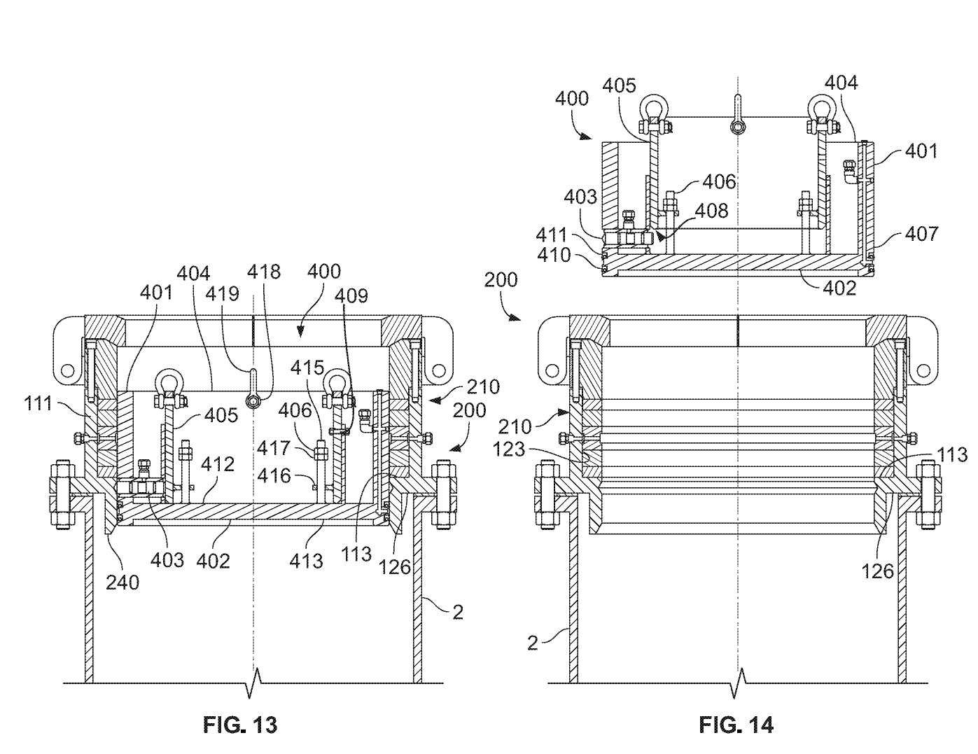

FIG. 13 depicts a cut-away elevation view of another illustrative cover 400 that can be connected to the support apparatus 210 of the conduit support assembly 200 secured within the support apparatus 110 of the conduit support assembly 200, as shown. FIG. 14 depicts a cut-away elevation view of the cover 400 shown in FIG. 13 in an unsecured state. It should also be understood that the cover 400 can also be secured within the support apparatus 110 of the conduit support assembly 100. Referring to FIGS. 1, 13, and 14 collectively, in some embodiments, the support apparatus 210 can include an extension ring 240 that can extend from the exterior or outer surface 126 of the support shoulder 113. In some embodiments, the cover 400 can include a cover tube 401, a cover plate 402, a plurality of pins 403, a bracket 404, a locking member 405, and a securing member 406.

In some embodiments, the cover tube 401 can be a cylindrical tube that can have an outer dimension, for example an outer diameter, that can be less than an inner dimension, for example, an inner diameter of the support apparatus 210. In some embodiments, the cover 400 can be configured to be inserted into or disposed at least partially within the support apparatus 210. In some embodiments, the cover tube 401 or the cover plate 402 can include at least one seal groove 410, two are shown. In some embodiments, a seal 411 can be disposed at least partially within the seal groove 410 and can create a barrier between an exterior or outer surface 407 of the cover 400 and the inner surface 123 of the support tube 111 of the support apparatus 200 or the extension ring 240 to at least partially prevent or restrict fluid communication between the body of water 4 and the interior space 5 of the buoy 7via the guide tube 2. In some embodiments, the seal groove 410 can be defined by the exterior or outer surface 407 of the cover tube 401 or an exterior or outer surface 413 of the cover plate 402. In some embodiments, the barrier can be a watertight barrier.

In some embodiments, the cover 400 can be configured to be secured to the extension ring 240 or the support shoulder 113 via a plurality of pins 403. In some embodiments, the pins 403 can be movable between a locked position, as shown in FIG. 13 and an unlocked position as shown in FIG. 14. In some embodiments, the pins 403 can be orientated in a radial direction or perpendicular or normal to the longitudinal axis 140. In some embodiments, the pins 403 can be secured in the locked position via a securing member 406. In some embodiments, the locking member 405 can be moved between a first position as shown in FIG. 13 and a second position as shown in FIG. 14. In some embodiments, the locking member 405 can include a locking profile 408 that can be configured to move the plurality of pins 403 from the unlocked position to the locked position as the locking member 405 moves from the second position to the first position. In some embodiments, the cover 400 can include a securing member 406 that can be configured secure the locking member 405 in the first position. In some embodiments, the securing member 406 can be configured with at least one threaded stud 415, two are shown. In some embodiments, the threaded stud 415, can be disposed on the cover plate 402 on an interior surface 412 thereof. In some embodiments, the securing member 406 can include a sleeve 416 through which the threaded stud 415 passes. In some embodiments, the securing member 406 can include at least one nut 417, two are shown, that can be threaded on to the at least one threaded stud 415. When the locking member 405 is in the first position, the nut 417 can be tightened against the sleeve 416 such that the locking member 405 is secured in the first position via the securing member 406. In some embodiments, one or more bolts or other fastener(s) 409 can be secured within a sidewall of the sleeve 416 and the locking member 405 to prevent accidental release of the locking member 405.

In some embodiments, the cover 400 can include the at least one bracket 404. In some embodiments, the bracket 404 can include at least one padeye 418 and one shackle 419. In some embodiments, the cover 400 can be removed by securing a lifting line, not shown, to the bracket 404 via the at least one padeye 418 and one shackle 419. The cover 400 can be removed from the support apparatus 110 by positioning the locking member 407 in the second position and positioning the pins 403 to the unlocked position and moving the cover 400 in a direction that is parallel with the longitudinal axis 140 of the support apparatus 210 in a direction toward the first end 120 of the support apparatus 210, for example lifting the cover 400 with a lifting line.

In some embodiments, the hang-off adapter 130 can be secured to the conduit 10. In some embodiments, a first load shoulder 132 can be disposed on an exterior or outer surface 131 of the hang-off adaptor 130. In some embodiments, the first load shoulder 132 can be configured to matingly engage with the split ring assembly 115 when the split ring assembly 115 is in the closed position. In some embodiments, the cover 300 or 400 can be configured to be secured (i) within or against the support apparatus 110/210 or (ii) against a second end 13 of the guide tube 2.

In some embodiments, when the cover 300, 400 is secured to or against the support apparatus 110/210 or the second end 13 of the guide tube 2, the cover 300, 400 can at least partially restricts fluid communication between an interior space 5 of the buoy 7 and the body of water 4. In some embodiments, when the cover 300, 400 is secured to or against the support apparatus 110/210 or the second end 13 of the guide tube 2, the cover 300, 400 can create a barrier between the cover and the support apparatus 110/210 or the guide tube 2. In some embodiments, the barrier can be watertight.

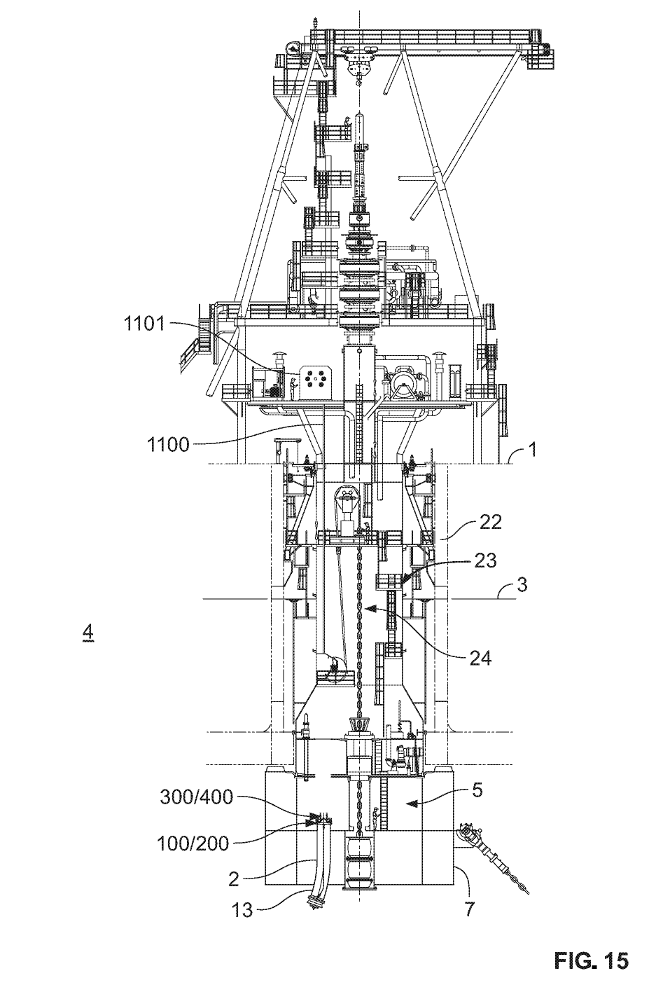

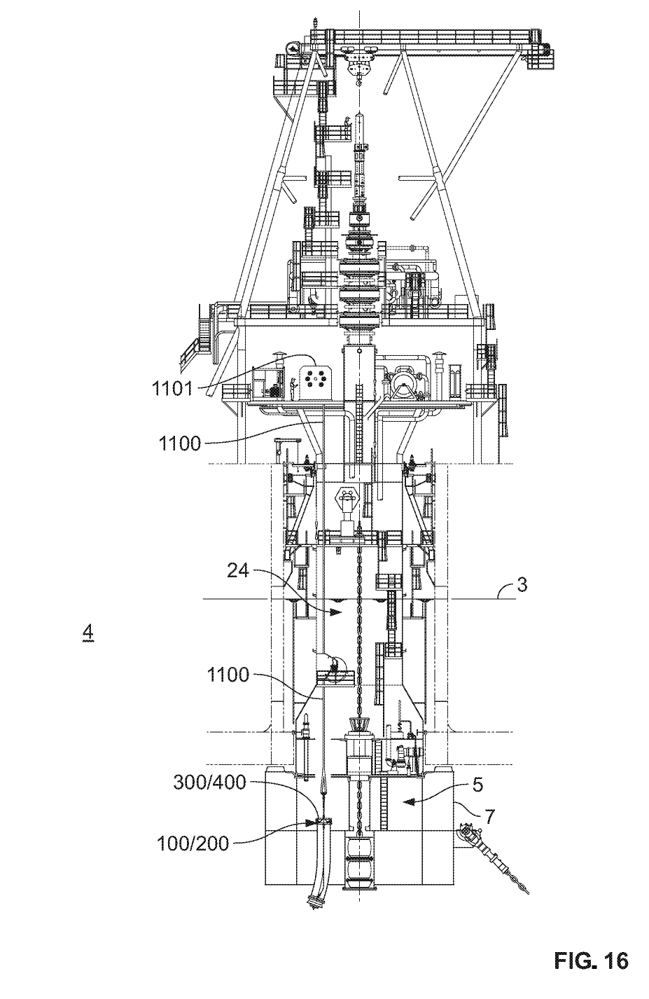

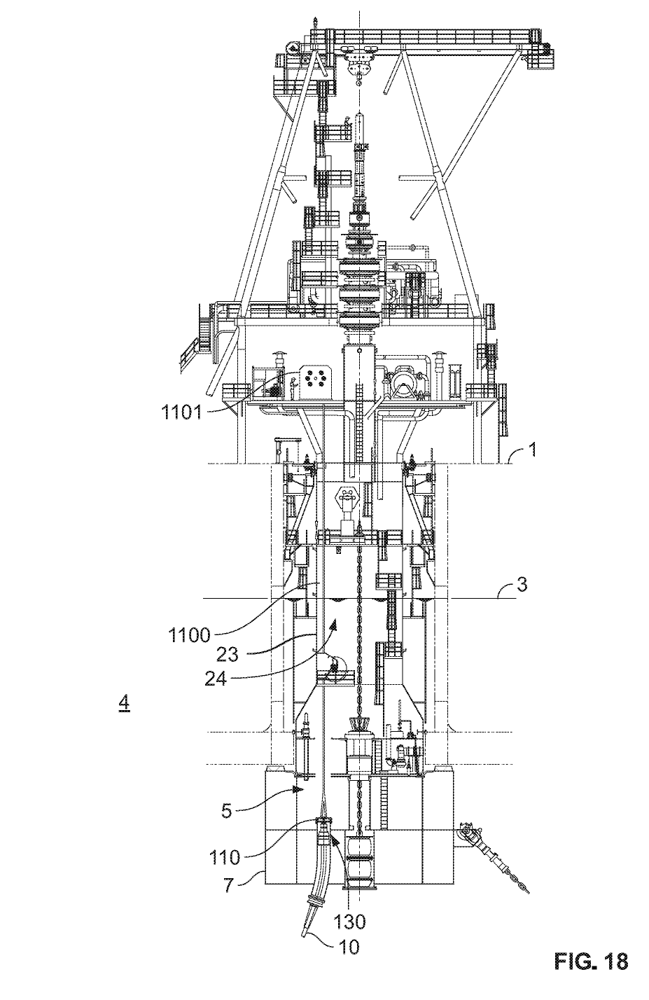

FIGS. 15 to 18 depict a process for supporting a load of a conduit 10 from a structure 1 floating on the surface 3 of the body of water 4 using the conduit support assembly 100, 200 shown in FIGS. 2 through 14. In some embodiments, the process can include filling an interior space 22 of the floating structure 1 or the interior space 5 of the buoy 7 or the interior space 24 of the turret shaft 23 with water, removing the cover 300, 400 from the second end 13 of the guide tube 2 or the support apparatus 110/210, positioning the hang-off adapter 130 partially within the support apparatus 110/210, moving the split ring assembly 115 to a closed position, transferring a load of the conduit 10 to the support apparatus 110/210 via the split ring assembly 115 and the first load shoulder 132 of the hang-off adapter 130, and removing the water from the interior space 22 of the floating structure 1, interior space 5 of the buoy 7, and/or an interior space 24 of the turret shaft 23.

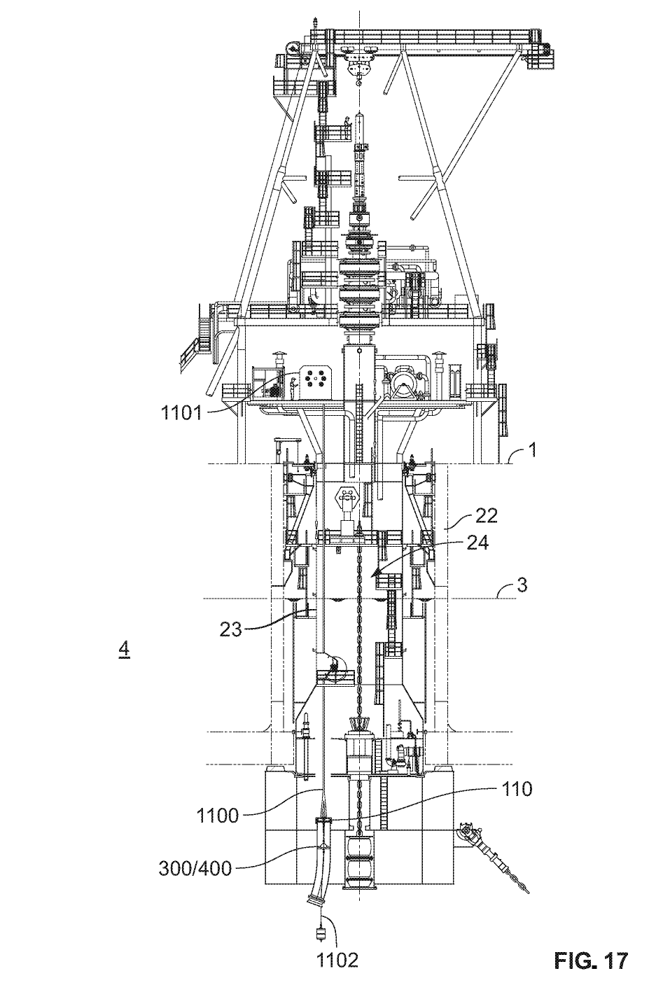

In some embodiments, the process can include connecting a first line 1100 from a first winch 1101 to the cover 300, 400, connecting a second line 1102 (see FIG. 17) from a second winch, not shown, disposed on an installation vessel, not shown to the cover 300, 400, paying out the first line 1100 with the first winch 1101 and pulling in the second line 1102 with the second winch to transfer the cover 300, 400 from the floating structure 1 to the installation vessel.

In some embodiments, the support apparatus 110/210 can include the extension ring 240 that extends from the exterior or outer surface 126 of the support shoulder 113. In such embodiments, the cover 300, 400 can be secured to the inner surface 241 of the extension ring 240 or an inner surface of the support shoulder 113 via the plurality of radial pins 403. In such embodiments, each pin of the plurality of pins 403 can be moveable between the locked position and the unlocked position, and the plurality of radial pins 403 can be secured in the locked position via the at least one securing member 406. In such embodiments, the process can include: connecting the first line 1100 from the first winch 1101 disposed on the floating structure 1 to the cover 300, 400, removing the at least one securing member 406, moving each pin 403 from the locked position to the unlocked position and pulling in on the first line 1100 with the first winch 1101.

In some embodiments, a conduit support assembly for supporting a conduit from a structure floating in a body of water can include a support apparatus that can be configured to be disposed on a first end of a guide tube. The guide tube can be disposed through a side shell or bottom plate of the structure below a surface of the body of water and can provide fluid communication between the body of water and an interior space of the structure. The support apparatus can include a support tube, a load ring, a seal, and a split ring assembly. The load ring can be attached to the support tube toward a first end thereof. The load ring can be moveable relative to the support tube in a direction that is parallel to a longitudinal axis of the support apparatus. A support shoulder can be located toward a second end of the support tube and can extend from an inner surface thereof. The seal can be disposed within the support tube between the load ring and the support shoulder. The split ring assembly can be configured to be movable between an open position and a closed position. The conduit support assembly can also include a hang-off adapter that can be configured to be secured to the conduit. The hang-off adaptor can include a first load shoulder disposed on an exterior surface thereof that can be configured to matingly engage with the split ring assembly when the split ring assembly is in the closed position. The conduit support assembly can also include a cover configured to be secured (i) within or against the support apparatus or (ii) against a second end of the guide tube. The support apparatus can be configured to allow the hang-off adapter to pass partially through the support apparatus from the second end toward the first end thereof when the split ring assembly is in the open position and the cover has been removed from the conduit support assembly. The first load shoulder of the hang-off adapter can be configured to engage with the split ring assembly to transfer a load of the conduit from the hang-off adapter to the load ring when the hang-off adapter is secured to the conduit and when the hang-off adapter has passed partially through the support apparatus and the split ring assembly is in the closed position. When the load of the conduit is transferred from the hang-off adapter to the load ring, the seal can be deformed to create a first barrier between the hang-off adapter and the support apparatus. When the hang-off adapter has been removed from the support apparatus and the cover is secured within or against the support apparatus or against the second end of the guide tube, the cover can at least partially restrict fluid communication between an interior space of the structure and the body of water.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are "about" or "approximately" the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A conduit support assembly, comprising:
a support apparatus configured to be disposed on a guide tube connected to a structure floating in a body of water, the support apparatus comprising:
a support tube;
a load ring attached to the support tube toward a first end thereof, wherein the load ring is moveable relative to the support tube in a direction that is parallel to a longitudinal axis of the support apparatus;
a support shoulder located toward a second end of the support tube and extending from an inner surface thereof;
a first seal disposed within the support tube between the load ring and an inner surface of the support shoulder; and
a split ring assembly configured to be movable between an open position and a closed position; and
a hang-off adapter configured to be secured to a conduit, comprising a first load shoulder disposed on an exterior surface thereof that is configured to matingly engage with the split ring assembly when the split ring assembly is in the closed position;
wherein:
the support apparatus is configured to allow the hang-off adapter to pass partially through the support apparatus from the second end toward the first end thereof when the split ring assembly is in the open position,
the first load shoulder of the hang-off adapter is configured to engage with the split ring assembly to transfer a load of the conduit from the hang-off adapter to the load ring when the hang-off adapter is secured to the conduit and the split ring assembly is in the closed position, and
when the load of the conduit is transferred from the hang-off adapter to the load ring, the first seal is deformed to create a first barrier between an exterior surface of the hang-off adapter and the support apparatus.

2. The assembly of claim 1, wherein, when the load of the conduit is transferred from the hang-off adapter to the load ring, the first seal is deformed to create the first barrier between the exterior surface of the hang-off adapter and an inner surface of the support tube and/or the inner surface of the support shoulder.

3. The assembly of claim 1, wherein:
the support apparatus further comprises a second seal and a first spacer ring,
the second seal is disposed within the support tube between the load ring and the support shoulder,
the first spacer ring is disposed within the support tube between the first seal and the second seal and is moveable relative to the support tube along the longitudinal axis of the support apparatus, and
when the load of the conduit is transferred from the hang-off adapter to the load ring, the second seal is deformed to create a second barrier between the exterior surface the hang-off adapter and the support apparatus.

4. The assembly of claim 3, wherein, when the load of the conduit is transferred from the hang-off adapter to the load ring, the second seal is deformed to create the second barrier between the exterior surface of the hang-off adapter and an inner surface of the support tube.

5. The assembly of claim 3, wherein the support tube and the first spacer ring define an injection port therethrough, and wherein the injection port is in fluid communication with a volume defined by the first seal, the second seal, an inner surface of the spacer ring, and the exterior surface of the hang-off adapter.

6. The assembly of claim 3, wherein:
the support tube and the first spacer ring each define a bore therethrough, and
the bores defined by the support tube and the first spacer ring are in fluid communication with one another and with a volume defined by the first seal, the second seal, an inner surface of the first spacer ring, and the exterior surface of the hang-off adapter.

7. The assembly of claim 1, wherein the hang-off adaptor is secured to the conduit via a mechanical connector.

8. The assembly of claim 7, wherein:
the hang-off adapter further comprises a second load shoulder disposed on an inner surface thereof, and
the mechanical connector comprises:
a mating ring configured to be partially disposed within a groove defined by the conduit or by an end termination of the conduit, and
a retainer ring configured to be secured to the hang-off adapter via a plurality of fasteners, wherein the retainer ring is configured to secure the mating ring partially within the groove defined by the conduit or the end termination of the conduit and partially on the second load shoulder of the hang-off adapter such that the load of the conduit is transferred from the conduit to the hang-off adapter via the mating ring.

9. The assembly of claim 1, wherein the hang-off adapter further comprises a stop shoulder disposed on the exterior surface thereof that is configured to prevent the hang-off adapter from passing completely through the support apparatus.

10. The assembly of claim 1, wherein:
the split ring assembly comprises two ring segments,
each ring segment comprises a third load shoulder that is configured to matingly engage with the first load shoulder, and
each ring segment is rotatable with respect to the load ring about an axis that is perpendicular to the longitudinal axis of the support apparatus.

11. The assembly of claim 10, wherein the split ring assembly is moved between the open position and the closed position via a hydraulic actuator, a pneumatic actuator, a screw jack, an electric actuator, or a combination thereof.

12. The assembly of claim 1, wherein:
the split ring assembly comprises two ring segments,
each ring segment comprises a third load shoulder that is configured to matingly engage with the first load shoulder, and
the two ring segments are rotatable with respect to one another about an axis that is parallel to the longitudinal axis of the support apparatus.

13. The assembly of claim 1, further comprising a cover configured to be secured against an exterior surface of the support shoulder or at least partially within an extension ring that extends from an exterior surface of the support shoulder to create a barrier between the cover and the support apparatus when the hang-off adapter is removed from the support apparatus.

14. The assembly of claim 13, wherein the cover is configured to be secured against the exterior surface of the support shoulder.

1515 The assembly of claim 13, wherein the cover is configured to be disposed at least partially within the extension ring that extends from the exterior surface of the support shoulder.

16. The assembly of claim 13, further comprising a seal configured to be disposed between the cover and the exterior surface of the support shoulder or an inner surface of the extension ring to create the barrier between the cover and the support apparatus.

17. The assembly of claim 1, wherein the split ring assembly is connected to the load ring or the support tube.

18. A process for connecting a conduit to a conduit support assembly disposed on a structure floating in a body of water, comprising:
filling an interior space of the structure with water, wherein:
a support apparatus of the conduit support assembly is disposed on a first end of a guide tube that is located within the interior space of the structure and in fluid communication with the body of water,
the support apparatus comprises a support tube, a load ring attached to the support tube toward a first end thereof, a support shoulder located toward a second end of the support tube and extending from an inner surface thereof, a first seal disposed on the inner surface of the support tube between the load ring and the support shoulder, and a split ring assembly configured in an open position,
the load ring is moveable relative to the support tube in a direction that is parallel to a longitudinal axis of the support apparatus,
a hang-off adapter of the conduit support assembly is secured to the conduit,
the hang-off adapter comprises a first load shoulder disposed on an exterior surface thereof that is configured to matingly engage with the split ring assembly when the split ring assembly is in a closed position, and
a cover of the conduit support assembly is secured to or against the support apparatus or against a second end of the guide tube to at least partially restrict fluid communication between the interior space of the structure and the body of water;
removing the cover from the guide tube;
positioning the hang-off adapter partially within the support apparatus;
moving the split ring assembly from the open position to the closed position so that the first load shoulder matingly engages with the split ring assembly;
transferring a load of the conduit to the support apparatus via the split ring assembly and the first load shoulder of the hang-off adapter; and
removing the water from the interior space of the structure.

19. A process for supporting a load of a conduit from a structure floating in a body of water with a conduit support assembly, comprising:
filling an interior space of the structure with water, wherein:
a support apparatus of the conduit support assembly is disposed on a first end of a guide tube that is located within the interior space of the structure and in fluid communication with the body of water,
the support apparatus comprises a support tube, a load ring attached to the support tube toward a first end thereof, a support shoulder located toward a second end of the support tube and extending from an inner surface thereof, a first seal disposed on the inner surface of the support tube between the load ring and the support shoulder, and a split ring assembly,
the load ring is moveable relative to the support tube in a direction that is parallel to a longitudinal axis of the support apparatus,
a hang-off adapter of the conduit support assembly is secured to the conduit, and
a cover of the conduit support assembly is secured within or against the support apparatus or against a second end of the guide tube to at least partially restrict fluid communication between the interior space of the structure and the body of water;
removing the cover from the guide tube or the support apparatus;
positioning the hang-off adapter partially within the support apparatus, wherein the hang-off adaptor comprises a first load shoulder disposed on an exterior surface thereof that is configured to matingly engage with the split ring assembly when the split ring assembly is in a closed position;
moving the split ring assembly from an open position to the closed position;
transferring a load of the conduit to the support apparatus via the split ring assembly and the first load shoulder of the hang-off adapter; and
removing the water from the interior space of the structure.

20. The process of claim 19, further comprising:
connecting a first line from a first winch disposed above the cover on the floating structure to the cover;
connecting a second line from a second winch disposed on an installation vessel to the cover;
paying out the first line with the first winch; and
pulling in the second line with the second winch to transfer the cover from the structure floating in the body of water to the installation vessel.
